(19) United States
(12) Patent Application Publication
(10) Pub. No.: US 2024/0379971 A1
(43) Pub. Date: Nov. 14, 2024

(54) SEPARATOR FOR FUEL CELL AND METHOD FOR MANUFACTURING SAME

(71) Applicants: SHIN-ETSU POLYMER CO., LTD., Tokyo (JP); DAINICHISEIKA COLOR & CHEMICALS MFG. CO., LTD., Tokyo (JP)

(72) Inventors: Masahiro TESHIMA, Saitama (JP); Masayuki Honda, Saitama (JP); Noritaka SAKUTA, Tokyo (JP); Tomoya FUJII, Tokyo (JP)

(21) Appl. No.: 18/258,558

(22) PCT Filed: Mar. 24, 2022
(86) PCT No.: PCT/JP2022/013985

§ 371 Date: Jun. 21, 2023

(51) Int. Cl. H01M 8/0213; H01M 8/0221; H01M 8/0228; H01M 8/0247; H01M 8/026

(52) U.S. Cl. CPC H01M 8/0213; H01M 8/0221; H01M 8/0228; H01M 8/0247; H01M 8/026

(57) ABSTRACT

An object is to provide a fuel cell separator and a manufacturing method thereof realizing excellent strength, electrical conductivity, and gas barrier property. The present invention is related to a fuel cell separator and a manufacturing method thereof, the fuel cell separator comprising: a plate that contains graphite and resin and comprises, on surfaces thereof, grooves, serving as flow paths; and surface layer films, that cover the surfaces on both sides of the plate in a thickness direction thereof, including the grooves, and the surfaces of the plate other than the grooves, wherein the surface layer films, contain resin and carbon nanotubes.

### RELATED APPLICATIONS

The present application is a National Phase of International Application No. PCT/JP2022/013985 filed Mar. 24, 2022.

### CROSS REFERENCE

The contents of the patents, patent applications, and documents cited in the present application are incorporated herein by reference.

### TECHNICAL FIELD

The present invention is related to a separator for fuel cell and method for manufacturing same.

### BACKGROUND ART

Fuel cells are cells from which energy is taken out by using a reaction between hydrogen and oxygen. Because what is generated from the reaction is water, fuel cells are known to be earth environment-friendly cells. In particular, for the capability of achieving high power density while being compact and lightweight, solid polymer fuel cells are considered as a favorable candidate for batteries of automobiles, communication devices, electronic devices and the like, while the actual implementation thereof is partially underway. A fuel cell is a cell stack in which a plurality of cells are stacked together. Plate-like members called separators are arranged between the cells. Each separator is a partition for separating paths for hydrogen and oxygen positioned adjacent to each other and plays a role in making the hydrogen and the oxygen flow while being in uniform contact with the entire surface of an ion exchange membrane. For this reason, grooves serving as flow paths are formed on the separators.

From a viewpoint of constituent materials, separators can roughly be divided into a metal material group and a carbon material group. For separators in the metal material group, generally speaking, stainless steel, aluminum or an alloy thereof, or titanium or an alloy thereof may be used. The separators in the metal material group have excellent processability and can be thin, due to strength and ductility specific to metal. However, the separators in the metal material group have higher specific gravity than separators in the carbon material group (explained later) and thus contradict the idea of making fuel cells lightweight. In addition, the separators in the metal material group have disadvantages where corrosion resistance is low and a passive film may be formed by some of the materials. Because of the possibility of an increase in electrical resistance of the separators, corrosion and passive films of metal materials are not desirable. When separators in the metal material group are coated with precious metal plating or sputtering to improve corrosion resistance, costs may increase. To keep the costs down, a method is known by which ridge parts of flow paths formed on a surface of a separator are formed with a photoresist film (see Patent Literature 1).

In contrast, the separators in the carbon material group have advantages where specific gravity is lower while corrosion resistance is higher, in comparison to the separators in the metal material group. However, the separators in the carbon material group are inferior in processability and mechanical strength. In addition, there is demand for making electrical resistance even lower (i.e., making electrical conductivity even higher). As a method for improving the mechanical strength, a separator is known, for example, in which graphite particles are dispersed in thermoplastic resin (see Patent Literature 2).

### CITATION LIST

### Patent Literature

Patent Literature 1: Japanese Patent Laid-Open No. 2011-090937
Patent Literature 2: Japanese Patent Laid-Open No. 2006-294407

### SUMMARY OF INVENTION

### Technical Problem

The method by which graphite particles are dispersed in thermoplastic resin is able to realize a stronger separator to a certain extent. However, the separators in the carbon material group are required to have even higher strength. In addition, there is also a demand for higher electrical conductivity and for a gas barrier property, which is the capability of preventing gas from passing through.

It is an object of the present invention to provide a fuel cell separator and a manufacturing method thereof realizing excellent strength, electrical conductivity, and gas barrier property.

### Solution to Problem

(1) To achieve the abovementioned object, a fuel cell separator according to an embodiment comprises: a plate that contains graphite and resin and comprises, on a surface thereof, a groove serving as a flow path; and a surface layer film that covers surfaces on both sides of the plate in a thickness direction thereof, including the groove and the surfaces of the plate other than the groove, wherein the surface layer film contains resin and carbon nanotubes.

(2) In a fuel cell separator according to another embodiment, the surface layer film may preferably contain polyphenylene sulfide as the resin.

(3) In a fuel cell separator according to another embodiment, a thickness of the surface layer film may preferably be in a range of 2 μm to 75 μm inclusive.

(4) In a fuel cell separator according to another embodiment, the carbon nanotubes may preferably be contained in an amount ranging from 0.5 parts by mass to 5 parts by mass inclusive, with respect to 100 parts by mass of the resin.

(5) In a fuel cell separator according to another embodiment, the carbon nanotubes may preferably be multi-walled carbon nanotubes.

(6) A fuel cell separator according to another embodiment may preferably further comprise an intermediate layer film that is provided inside the plate in the thickness direction thereof and that divides the thickness direction thereof into at least two regions, wherein the intermediate layer film may contain resin and carbon nanotubes.

(7) A fuel cell separator according to another embodiment may preferably comprise two or more layers of the intermediate layer film.

(8) In a fuel cell separator according to another embodiment, a thickness of the intermediate layer film may preferably be larger than the thickness of the surface layer film.

(9) In a fuel cell separator according to another embodiment, the plate may preferably contain aramid fiber different from the resin.

(10) To achieve the abovementioned object, a fuel cell separator manufacturing method according to an embodiment is a method for manufacturing the fuel cell separator of any one of the above, comprising: a first surface layer film arranging step of arranging the surface layer film in a mold; a shaping material arranging step of arranging a shaping material containing graphite and resin on the surface layer film; a second surface layer film arranging step of arranging the surface layer film over the shaping material; and a shaping step of performing a shaping process by closing the mold while the shaping material is sandwiched between the surface layer films.

(11) In a fuel cell separator manufacturing method according to another embodiment, the mold may preferably comprise, on inside thereof, an uneven surface for transferring the groove; and in the shaping step, the shaping material may be shaped and the groove may be formed, by using the mold comprising the uneven surface.

(12) A fuel cell separator manufacturing method according to another embodiment may preferably further comprise: a preliminary shaping step of obtaining, prior to the shaping material arranging step, the shaping material in a semi-solidified state from a mixture containing the graphite and the resin, wherein in the shaping material arranging step, the shaping material in the semi-solidified state may be arranged on the surface layer film.

(13) A fuel cell separator manufacturing method according to another embodiment may preferably further comprise: an intermediate layer film arranging step of arranging, over the shaping material in the mold, an intermediate layer film that is provided inside the plate in the thickness direction thereof and that divides the thickness direction thereof into at least two regions, wherein the shaping material arranging step may include a first shaping material arranging step of arranging, on the surface layer film, a mixture containing the graphite and the resin as the shaping material, and a second shaping material arranging step of arranging, on the intermediate layer film, a mixture containing the graphite and the resin, as the shaping material, in the intermediate layer film arranging step, the intermediate layer film may be arranged over the mixture arranged in the first shaping material arranging step; in the shaping step, the shaping process may be performed by closing the mold while a layered structure including at least the mixture, the intermediate layer film, and the mixture is sandwiched between the surface layer films; and before the shaping step, the intermediate layer film arranging step and the second shaping material arranging step may each be performed once or two or more times repeatedly.

(14) A fuel cell separator manufacturing method according to another embodiment may preferably further comprise: a preliminary shaping step of obtaining, prior to the second surface layer film arranging step, the shaping material in a semi-solidified state from the layered structure, wherein in the second surface layer film arranging step, the surface layer film may be arranged over the shaping material in the semi-solidified state; and in the shaping step, the shaping process may be performed by closing the mold while the shaping material in the semi-solidified state is sandwiched between the surface layer films.

(15) In a fuel cell separator manufacturing method according to another embodiment, prior to the shaping step, a preliminary shaping step may preferably be performed to obtain the shaping material in the semi-solidified state from the layered structure; and the shaping step may be performed on the shaping material in the semi-solidified sate.

(16) A fuel cell separator manufacturing method according to another embodiment may preferably further comprise: a film manufacturing step of manufacturing the surface layer film and/or the intermediate layer film in a form where the carbon nanotubes are dispersed in the resin as a result of mixing the carbon nanotubes with the resin in a melted state.

### Advantageous Effects of Invention

The present invention is able to provide the fuel cell separator and the manufacturing method thereof realizing excellent strength, electrical conductivity, and gas barrier property.

### BRIEF DESCRIPTION OF DRAWINGS

FIG. 1 presents a plan view of a fuel cell separator according to a first embodiment of the present invention.

FIG. 2 presents a cross-sectional view of the fuel cell separator in FIG. 1 at A-A, an enlarged view of B which is a part thereof, and an enlarged view of C which is a part of the enlarged view of B.

FIG. 3 shows an example of a flow in main steps in a fuel cell separator manufacturing method according to the first embodiment.

FIGS. 4A to 4F present cross-sectional views of statuses at the steps in the manufacturing method in FIG. 3.

FIGS. 5G to 5J present cross-sectional views of statuses at the steps following FIGS. 4A to 4F.

FIG. 6 shows an example of a flow in main steps in a fuel cell separator manufacturing method according to a second embodiment.

FIGS. 7A to 7F present cross-sectional views of statuses at the steps in the manufacturing method in FIG. 6.

FIGS. 8G to 8L present cross-sectional views of statuses at the steps following FIG. 7A to 7F.

FIG. 9 presents a cross-sectional view of a status when grooves are formed in a pre-shaped body in a semi-solidified state, in a fuel cell separator manufacturing method according to a modification example.

FIG. 10 presents a cross-sectional view of a fuel cell separator according to the second embodiment at A-A similar to FIG. 2, an enlarged view of B which is a part thereof, and an enlarged view of C which is a part of the enlarged view of B.

FIG. 11 shows an example of a flow in main steps in a fuel cell separator manufacturing method according to the second embodiment.

FIG. 12 shows an example of a flow in main steps in a manufacturing method different from FIG. 11.

FIG. 13 presents a schematic diagram of a continuous shaping device used in a modification example of a fuel cell separator manufacturing method.

FIG. 14 shows partial steps in the modification example in which a pre-shaped body shown in FIG. 13 is manufactured before separators are shaped.

### REFERENCE SIGNS LIST

1, 1a fuel cell separator; 2 plate; 2a mixture (an example of a shaping material); 4, 5 surface layer film; 6 intermediate layer film; 30, 32, groove; 31 surface; 40, 45 bottom mold (a component part of a mold); 41, 46, 51, 56 recessed part; 42, 52 uneven surface; 50, 55 top mold (a component part of the mold); 60, 65 mold; 70, 70a, 70b pre-shaped body (an example of a shaping material).

### DESCRIPTION OF EMBODIMENTS

Embodiments of the present invention will be explained with reference to the drawings. The embodiments described below do not limit the invention set forth in the claims. Further, the various elements described in the embodiments and combinations thereof are not all necessarily requisite for the problem solving means of the present invention.

### First Embodiment

### 1. A Fuel Cell Separator

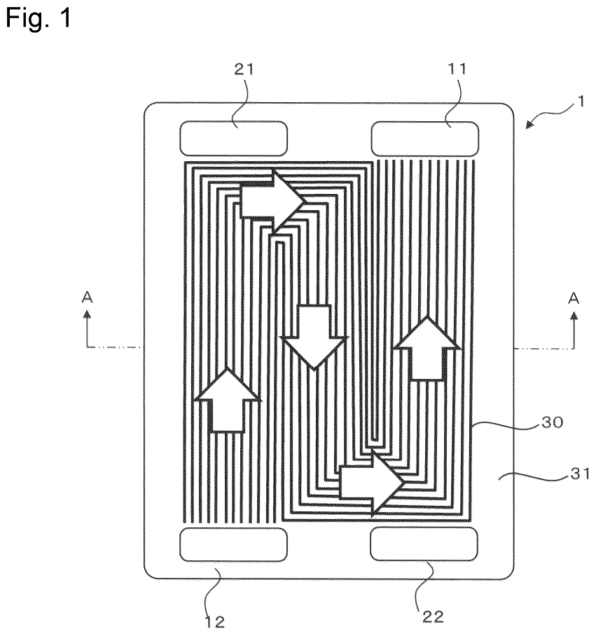

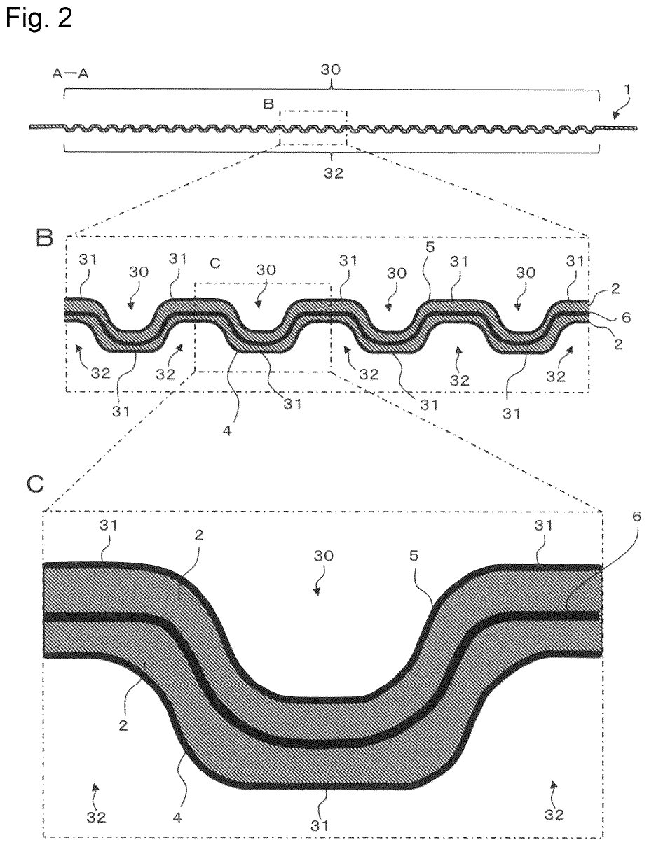

FIG. 1 presents a plan view of a fuel cell separator according to a first embodiment of the present invention. FIG. 2 presents a cross-sectional view of the fuel cell separator in FIG. 1 at A-A, an enlarged view of B which is a part thereof, and an enlarged view of C which is a part of the enlarged view of B.

A fuel cell separator (which hereinafter may simply be referred to as “separator”) 1 according to the present embodiment is a plate-like body having a substantially rectangular shape in a planar view. In a fuel cell, the separator 1 is the plate-like body that may sandwich, from both sides, a Membrane Electrode Assembly (MEA) in which an electrolyte membrane is interposed between an air electrode and a hydrogen electrode positioned on the two surfaces thereof. In the present embodiment, the separator 1 is interpreted in a broader sense including an anode-side separator provided on the hydrogen electrode (“anode electrode”) side and a cathode-side separator provided on the air-electrode (“cathode electrode”) side.

The separator 1 comprises through holes 11, 12, 21, and 22 penetrating in the thickness direction thereof. The through holes 11 and 21 are positioned on one end side of the separator 1. The through hole 12 is positioned on the other end side opposite the one end side of the separator 1, while being positioned opposite the through hole 21 in a planar view of the separator 1. The through hole 22 is positioned on the other end side opposite the one end side of the separator 1, while being positioned opposite the through hole 11 in a planar view of the separator 1. On one of the surfaces (a front surface) of the separator 1, grooves 30 serving as flow paths are formed. A surface 31 other than the grooves 30 is formed as a raised plane in contrast to the grooves 30. On the other surface (a rear surface) on the opposite side of the one surface of the separator 1, grooves 32 serving as flow paths are formed. A surface 31 other than the grooves 32 is formed as a raised plane in contrast to the grooves 32.

When the separator 1 is a cathode-side separator, the through hole 12 serves as an oxidization gas supply opening. The through hole 11 serves as an oxidization gas discharge opening. The through hole 22 serves as a hydrogen gas discharge opening. The through hole 21 serves as a hydrogen gas supply opening. The oxidization gas may be air, for example, but may be oxygen. The grooves 30 on the front surface of the separator 1 serve as flow paths in which the oxidization gas flows. The grooves 32 on the rear surface of the separator 1 serve as flow paths in which cooling water flows. In FIG. 1, the white arrows indicate flows of the oxidization gas.

When the separator 1 is an anode-side separator, the through hole 12 serves as a hydrogen gas supply opening. The through hole 11 serves as a hydrogen gas discharge opening. The through hole 22 serves as an oxidization gas discharge opening. The through hole 21 serves as an oxidization gas supply opening. The grooves 30 on the front surface of the separator 1 serve as flow paths in which the hydrogen gas flows. The grooves 32 on the rear surface of the separator 1 serve as flow paths in which cooling water flows.

The separator 1 comprises at least a plate 2 and surface layer films 4 and 5. In the present embodiment, the separator 1 preferably comprises an intermediate layer film 6 that is provided inside the plate 2 in the thickness direction thereof and that divides the thickness direction thereof into at least two regions.

### (The Plate)

The plate 2 is a plate that contains graphite and resin and comprises, on the surfaces thereof, the grooves 30 and 32 serving as the flow paths. The plate 2 is a shaped body containing the graphite and the resin and has a fine structure in which the graphite is dispersed in the resin that was melted and subsequently solidified. The plate 2 may comprise fiber in addition to the graphite and the resin. The fiber may be of any type such as resin fiber, carbon fiber, ceramic fiber, and/or the like, but is preferably resin fiber, and more preferably aramid fiber. When the plate 2 comprises the fiber, it is possible to further enhance the strength of the plate 2. The plate 2 comprises grooves corresponding to the grooves 30 and 32 of the separator 1. In a planar view, the area of the plate 2 is preferably in the range of 10 cm² to 1000 cm², and more preferably in the range of 100 cm² to 750 cm². The thickness of the plate 2 is preferably in the range of 0.05 mm to 20 mm, more preferably in the range of 0.10 mm to 15 mm, and even more preferably in the range of 0.15 mm to 10 mm. When the plate 2 is thinner than 0.05 mm, the mechanical strength of the plate 2 would be insufficient. When the thickness is larger than 20 mm, penetration resistance and weight would increase. Thus, it is preferable to have a thickness in the above range.

The resin structuring the plate 2 is not particularly limited, but is preferably thermoplastic resin. Resin having excellent heat resistance is more preferable for the resin to structure the plate 2. More specifically, examples include: polyphenylene sulfide (PPS), polyether ether ketone (PEEK), a polyamide (PA), polyether ketone ether ketone ketone (PEKEKK), polyether ketone (PEK), a liquid crystal polymer (LCP), polytetrafluoroethylene (PTFE), a copolymer of tetrafluoroethylene and ethylene (ETFE), polychlorotrifluoroethylene (PCTFE), polyimide (PI), a polyamide-imide (PAI), polyethersulfone (PES), polyphenylsulfone (PPSU), polyetherimide (PEI), and a polysulfone (PSU). Among these, PPS or PEEK is particularly preferable. Examples of PPS include M2888 and E2180 produced by Toray Industries, Inc. and FZ-2140 and FZ-6600 produced by Dainippon Ink and Chemicals, Inc.

The average particle diameter of the resin used before shaping the plate 2 is preferably in the range of 1 μm to 300 μm inclusive, more preferably in the range of μm to 150 μm inclusive, and even more preferably in the range of 10 μm to 100 μm inclusive. In this situation, the average particle diameter denotes a particle diameter measured by using a laser diffraction/scattering particle diameter distribution measuring method. The same applies to the method for measuring the average particle diameters hereinafter.

The graphite structuring the plate 2 may be any of the following: artificial graphite, expanded graphite, natural graphite, and others. In this situation, the expanded graphite denotes graphite or a graphite intercalation compound obtained by expanding the spaces between graphite layers by having a layer of another substance enter (called “intercalation”) on a specific plane in a structure in which regular hexagonal planes of graphite are stacked together. As the expanded graphite, BSP-60A (having an average particle diameter of 60 μm) or EXP-50SM produced by Fuji Graphite Works Co., Ltd. may be used, for example. As the artificial graphite, 1707SJ (average particle diameter: 125 μm), AT-No. 5S (average particle diameter: 52 μm), AT-No. 10S (average particle diameter: 26 μm), or AT-No. 20S (average particle diameter: 10 μm) produced by Oriental Sangyo Co., Ltd. or PAG or HAG produced by Nippon Graphite Industries, Co., Ltd. may be used, for example. As the natural graphite, CNG-75N (average particle diameter: 43 μm) produced by Fuji Graphite Works Co., Ltd. or CPB (flake-form graphite powder having an average particle diameter of 19 μm) produced by Nippon Graphite Industries, Co., Ltd. may be used. Further, the shapes of the graphite particles are not particularly limited. It is possible to select from exfoliated pieces, flakes, and spherical shapes, as appropriate. Further, the graphite may partially contain amorphous carbon.

The average particle diameter of the graphite used before shaping the plate 2 is preferably in the range of 1 μm to 500 μm inclusive, more preferably in the range of 3 μm to 300 μm inclusive, and even more preferably in the range of 10 μm to 150 μm inclusive.

The particle diameters of the graphite and the resin may be adjusted separately before the two are mixed together to be used for shaping the plate 2. Alternatively, the graphite and the resin may be kneaded together at first, before being pulverized so that the particle diameters are adjusted for the use in shaping the plate 2. When the graphite and the resin are kneaded together before being pulverized so that the particle diameters are adjusted, the average particle diameter of a powder mixture is preferably in the range of 1 μm to 500 μm inclusive, more preferably in the range of 3 μm to 300 μm inclusive, and even more preferably in the range of 10 μm to 150 μm inclusive.

The mass ratio between the graphite and the resin structuring the plate 2 can be defined as: graphite:resin=70 to 97 parts by mass:30 to 3 parts by mass. For example, by mixing 3 parts by mass of the resin with the graphite in an amount ranging from 70 parts by mass to 97 parts by mass inclusive, it is possible to obtain a constituent material of the separator 1. As another example, by mixing 30 parts by mass of the resin with the graphite in an amount ranging from 70 parts by mass to 97 parts by mass inclusive, it is also similarly possible to obtain a constituent material of the separator 1. It is preferable to configure the separator 1 to contain more graphite than resin by a mass ratio. A more preferable mass ratio between the graphite and the resin is achieved by mixing 1 part by mass of the resin, with 10 parts by mass of the graphite or with the graphite in an amount ranging from 10.1 parts by mass to 30 parts by mass inclusive. As explained above, when more graphite than resin is used by parts by mass, because graphite particles have more contact sites with one another than in conventional separators, it is possible to further lower the electrical resistance (i.e., to further increase the electrical conductivity) of the separator 1. In a typical sample of the separator 1, the penetration resistance is 25 mΩ·cm² or lower. The penetration resistance denotes resistance occurring in the layer direction as observed in a layered body in which the separator 1 is sandwiched between gas diffusion layer base members.

### (The Surface Layer Films)

The surface layer films 4 and 5 are films covering the surfaces on both sides of the plate 2 in the thickness direction thereof. The surface layer films 4 and 5 cover the surface on the front side and the surface on the rear side of the plate 2, including the grooves 30, 32 and the surfaces 31 of the plate 2 other than the grooves 30, 32. In other words, the surface layer films 4 and 5 cover both the surface on the front side and the surface on the rear side of the plate 2 including the faces inside the grooves 30 and 32. In the present embodiment, the surface layer film 4 covers the face of the plate 2 on one of the two sides in the thickness direction, whereas the surface layer film 5 covers the face on the other side in the thickness direction. However, the surface layer film may have a bag-like shape in which the surface layer film 4 and the surface layer film 5 are joined together, to wrap the outside surfaces of the plate 2.

The surface layer films 4 and 5 are films containing resin and carbon nanotubes. As for the resin structuring the surface layer films 4 and 5, one or two or more may be selected as principal material(s) from among the abovementioned preferable options for the resin to structure the plate 2, and more preferably PPS may be used as the principal material. In this situation, the “principal material” denotes a material that accounts for more than 50 mass % of the surface layer films 4, 5. As long as the principal material accounts for more than 50 mass % relative to the mass of the surface layer films 4 and 5, the percentage may be 51 mass %, 60 mass %, 70 mass %, 80 mass %, 90 mass %, or 95 mass %, for example.

The carbon nanotubes (which hereinafter may be referred to as “CNTs”), which is one of the constituent elements of the surface layer films 4 and 5, may be single-walled carbon nanotubes (SWCNTs), double-walled carbon nanotubes (DWCNTs), multi-walled carbon nanotubes (MWCNTs), or a mixture of two or more of these, and preferably contains MWCNTs principally. In this situation, a CNT is a hollow carbon tube in which a graphene sheet having six-membered carbon ring mesh is rolled into a tube shape. A SWCNT is a hollow carbon tube in which a single-layer graphene sheet is rolled into the tube. A DWCNT is a hollow carbon tube having two tube-shaped graphene sheets disposed coaxially. A multi-walled carbon nanotube is a hollow carbon tube having three or more tube-shaped graphene sheets disposed coaxially. Although not particularly limited, diameters of the CNTs are in the range of 0.5 nm to 300 nm inclusive, preferably in the range of 3 nm to 200 nm inclusive, and more preferably in the range of 5 nm to 155 nm inclusive. Although not particularly limited, the length of each of the CNTs is in the range of 0.1 μm to 500 μm inclusive, preferably in the range of 0.5 μm to 200 μm inclusive, and more preferably in the range of 1.5 μm to 100 μm inclusive. The diameters and the lengths of the CNTs are based on diameters of the CNTs measured by a Transmission Electron Microscope (TEM) or a Scanning Electron Microscope (SEM) with a field of view of 100. Further, the shapes and manufacturing methods of the CNTs are not particularly limited and may be selected as appropriate.

With respect to 100 parts by mass of the resin structuring the surface layer films 4 and 5, the CNTs structuring the surface layer films 4 and 5 are contained in an amount preferably in the range of 0.5 parts by mass to 5 parts by mass inclusive, and more preferably in the range of 1 part by mass to 4 parts by mass inclusive. Because the surface layer films 4 and 5 contain the CNTs in this manner, it is possible to lower the penetration resistance (i.e., to increase the electrical conductivity) and to enhance the gas barrier property, in comparison to conventional separators.

The thickness of each of the surface layer films 4 and 5 is preferably in the range of 2 μm to 75 μm inclusive and more preferably in the range of 5 μm to 50 μm inclusive. When the thickness of each of the surface layer films 4 and 5 is 2 μm or larger, or even 5 μm or larger, it is possible to further enhance the gas barrier property and to also further enhance the strength (the bending strength) of the separator 1, which improves tractability. On the contrary, when the thickness of each of the surface layer films 4 and 5 is 75 μm or smaller, or even 50 μm or smaller, it is possible to further lower the penetration resistance (i.e., to further increase the electrical conductivity) of the separator 1. In the present embodiment, the strength denotes a bending strength measured according to JIS K7171.

The principal material of the resin structuring the plate 2 and the principal material of the resin structuring the surface layer films 4 and 5 may be the same type of thermoplastic resin. In that situation, because it is possible to integrally form the resin in the vicinity of the surfaces of the plate 2 with the surface layer films 4 and 5 covering the plate 2, it is possible to further increase the strength of the separator 1. The thermoplastic resin is, preferably, PPS.

### (The Intermediate Layer Film)

As mentioned earlier, the present embodiment further comprises the intermediate layer film 6 that is provided inside the plate 2 in the thickness direction thereof and that divides the thickness direction thereof into at least two regions. The present embodiment comprises only the one intermediate layer film 6 in the plate 2. Accordingly, the plate 2 is divided by the single-layer intermediate layer film 6 so that the thickness direction of the plate 2 is divided into the two regions. However, the plate 2 may comprise two or more layers of the intermediate layer film 6. In that situation, the plate 2 is divided by the two or more layers of the intermediate layer film 6 so that the thickness direction of the plate 2 is divided into three or more regions.

The intermediate layer film 6 is preferably a film containing resin and CNTs. As for the resin structuring the intermediate layer film 6, one or two or more may be selected as principal material(s) from among the abovementioned preferable options for the resin to structure the plate 2, and more preferably at least one of PEEK and PPS may be used as the principal material(s). In this situation, the “principal material” denotes a material that accounts for more than 50 mass % of the surface layer films 4 and 5. As long as the principal material accounts for more than 50 mass % relative to the mass of the surface layer films 4 and 5, the percentage may be 51 mass %, 60 mass %, 70 mass %, 80 mass %, 90 mass %, or 95 mass %, for example. The CNTs structuring the intermediate layer film 6 may be any of the abovementioned preferable options for the CNTs to structure the surface layer films 4 and 5. The content amount of the CNTs structuring the intermediate layer film 6 is similar to that in the surface layer films 4 and 5.

The preferable range for the thickness of the intermediate layer film 6 and the merit of adopting the thickness range are the same as those of the surface layer films 4 and 5. In addition, it is preferable to make the thickness of the intermediate layer film 6 larger than the thicknesses of the surface layer films 4 and 5. The reasons is that it is easier to bring the surface layer films 4 and 5 into close contact to be fit along the external surfaces of the plate 2 including the grooves 30 and 32.

The principal material of the resin structuring the plate 2 and the principal material of the intermediate layer film 6 may be the same type of thermoplastic resin. In that situation, because it is possible to partially integrally form the resin of the plate 2 in the vicinity of the intermediate layer film 6 with the intermediate layer film 6, it is possible to further increase the strength of the separator 1. The thermoplastic resin is, preferably, PEEK or PPS.

### 2. A Fuel Cell Separator Manufacturing Method

Next, a fuel cell separator manufacturing method according to the first embodiment of the present invention will be explained.

The separator 1 includes: a film manufacturing step of manufacturing the surface layer films 4 and 5 and the intermediate layer film 6 in the form where the carbon nanotubes are dispersed in the resin, as a result of mixing the carbon nanotubes with the resin in a melted state; a first surface layer film arranging step of arranging the surface layer film 4 in a mold; a shaping material arranging step of arranging a material to be shaped (hereinafter, “shaping material”) containing graphite and resin on the surface layer film 4; a second surface layer film arranging step of arranging the surface layer film 5 over the shaping material; and a shaping step of performing a shaping process by closing the mold while the shaping material is sandwiched between the surface layer films 4 and 5. Further, the manufacturing method of the separator 1 (hereinafter, simply “manufacturing method”) further includes an intermediate layer film arranging step of arranging the intermediate layer film 6 over the shaping material in the mold. The shaping material arranging step includes: a first shaping material arranging step of arranging, on the surface layer film 4, a mixture containing graphite and resin as a shaping material; and a second shaping material arranging step of arranging, on the intermediate layer film 6, a mixture containing graphite and resin as a shaping material. In the shaping step, a shaping process is performed by closing the mold, while a layered structure including at least the mixture, the intermediate layer film, and the mixture is sandwiched between the surface layer films 4 and 5. Further, before the shaping step, the intermediate layer film arranging step and the second shaping material arranging step are each performed once or two or more times repeatedly.

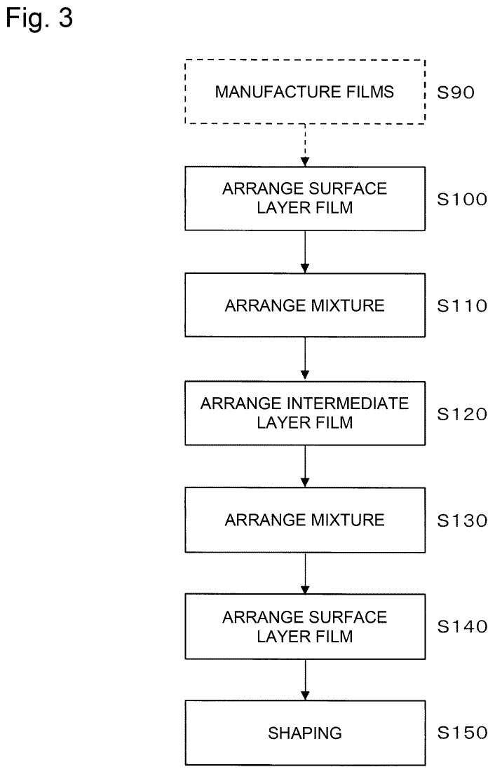

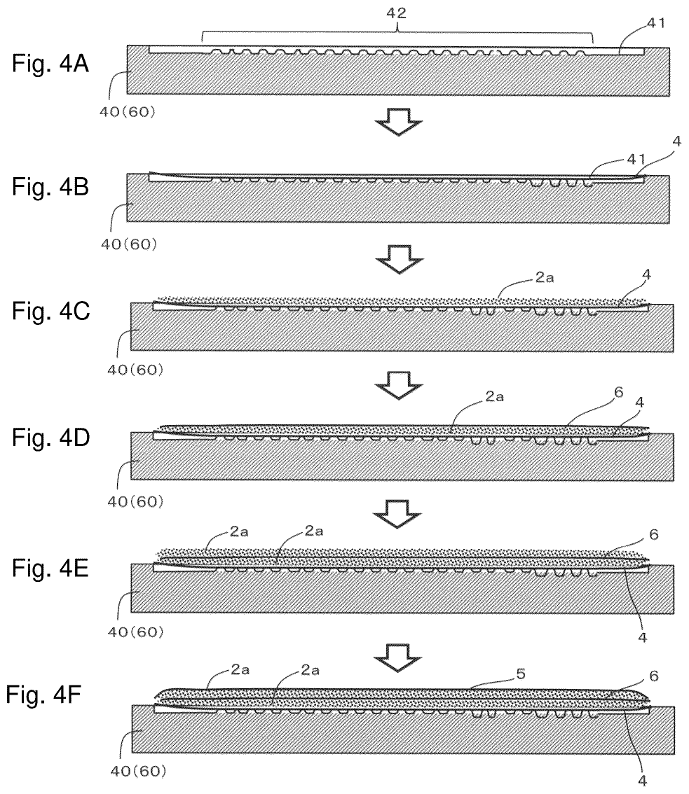

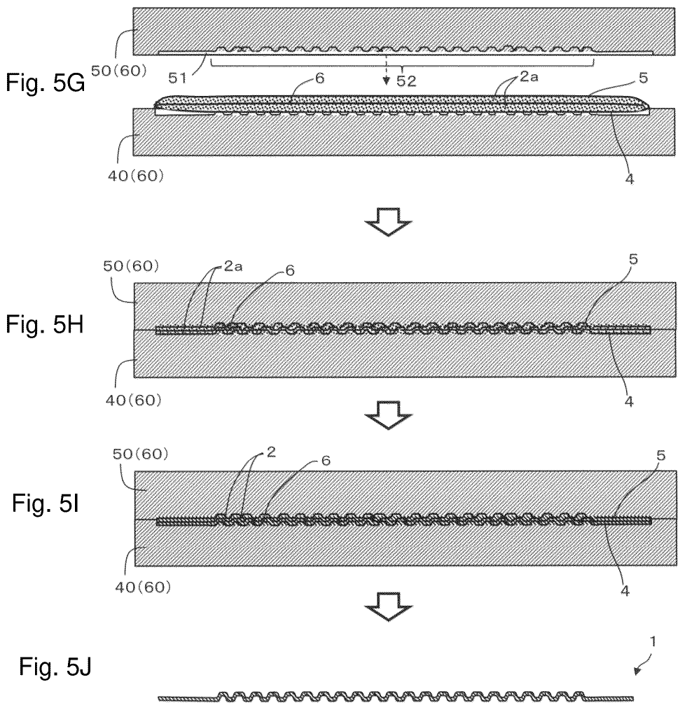

FIG. 3 shows an example of a flow in main steps in a fuel cell separator manufacturing method according to the first embodiment. FIGS. 4A to 4F present cross-sectional views of statuses at the steps in the manufacturing method in FIG. 3. FIGS. 5G to 5J present cross-sectional views of statuses at the steps following FIGS. 4A to 4F.

It is possible to manufacture the separator 1 through a film manufacturing step (S90), a first surface layer film arranging step (S100), a first shaping material arranging step (S110), an intermediate layer film arranging step (S120), a second shaping material arranging step (S130), a second surface layer film arranging step (S140), and a shaping step (S150). In the following sections, S90 through S150 will be explained in detail with reference to FIGS. 3 to 5.

### (1) The Film Manufacturing Step (S90)

This step is a step of manufacturing a film in the form where the CNTs are dispersed in the resin as a result of mixing the CNTs with the resin in a melted state. In this step, for example, PPS serving as an example of the resin and the CNTs are melted and kneaded by using a twin screw kneading extruder comprising a strand die, and strands of a compound obtained in this manner are made into pellets. The method for producing the pellets may be a method by which PPS is mixed with the CNTs for the purpose of enhancing the dispersion of the CNTs; the mixture is further mixed after adding water thereto; and water is removed while the obtained CNT/resin mixture is kneaded to produce the pellets. To an extent that advantageous effects of the present invention can be sustained, the pellets may contain, as necessary, any of various types of additives such as a plasticizer, a polymer dispersant, an ultraviolet ray absorbent, an antioxidant, a light stabilizer, a lubricant, a nucleating agent, a filler, a pigment, a flame retardant and/or the like. Among these, it is preferable to have the polymer dispersant contained because it is possible to further enhance dispersibility of the carbon nanotubes. Preferable examples of the polymer dispersant include a block copolymer structured with a methacrylate-based monomer or a methacrylic acid-based monomer and prepared by implementing a living radical polymerization method. It is preferable to adopt a method of shaping a PPS film in which the CNTs are dispersed by which the produced pellets are input to a twin screw extruder comprising a T-die to be extruded from the die at the tip end of the machine, so that the extruded film is collected while being cooled by air. In the present embodiment, the surface layer films 4 and 5 and the intermediate layer film 6 are shaped at once. However, the films 4, 5, and 6 may individually be shaped. Further, this step is sufficient when being a step of manufacturing at least the surface layer film 4. The intermediate layer film 6 may be manufactured at any stage before the intermediate layer film arranging step (S120). Similarly, the surface layer film 5 may be manufactured at any stage before the second surface layer film arranging step (S140). Furthermore, when a film in the form where the carbon nanotubes are dispersed in the resin is available for purchase or the like without manufacturing the film, it is possible to omit the film manufacturing step (S90).

### (2) The First Surface Layer Film Arranging Step (S100)

This step is a step of arranging the surface layer film 4 in a mold 60. More specifically, a bottom mold 40 structuring the mold 60 is prepared, and the surface layer film 4 is placed in a recessed part 41 of the bottom mold 40 (see FIGS. 4A and 4B). On the inner bottom face of the recessed part 41, the bottom mold 40 comprises an uneven surface 42 capable of transferring and forming the grooves 32.

### (3) The First Shaping Material Arranging Step (S110).

This step is a step of arranging a mixture 2a containing the graphite and the resin on the surface layer film 4, as a shaping material. More specifically, the mixture 2a is supplied to the top of the surface layer film 4 placed in the bottom mold 40 (see FIG. 4C).

### (4) The Intermediate Layer Film Arranging Step (S120)

This step is a step of arranging the intermediate layer film 6 over the mixture 2a in the mold 60. More specifically, the intermediate layer film 6 is placed over the mixture 2a on the surface layer film 4 arranged in the recessed part 41 of the bottom mold 40 (see FIG. 4D).

### (5) The Second Shaping Material Arranging Step (S130)

This step is a step of arranging the mixture 2a containing the graphite and the resin on the intermediate layer film 6, as a shaping material. More specifically, the mixture 2a is supplied to the top of the intermediate layer film 6 in the bottom mold 40 (see FIG. 4E).

### (6) The Second Surface Layer Film Arranging Step (S140)

This step is a step of arranging the surface layer film 5 over the mixture 2a in the mold 60, after the second shaping material arranging step (S130). More specifically, the surface layer film 5 is placed over the mixture 2a on the intermediate layer film 6 arranged in the recessed part 41 of the bottom mold 40 (see FIG. 4F).

### (7) The Shaping Step (S150)

This step is a step of performing a shaping process by closing the mold 60 while the layered structure including the mixture 2a, the intermediate layer film 6, and the mixture 2a is sandwiched between the surface layer films 4 and 5. More specifically, a top mold 50 structuring the mold 60 is prepared and placed over the bottom mold 40 on the recessed part 41 side, and the bottom mold 40 and the top mold 50 are closed together (see FIGS. 5G to 5H). The top mold 50 has a recessed part 51 on the side facing the recessed part 41 of the bottom mold 40. On the inner bottom face thereof, the recessed part 51 comprises an uneven surface 52 capable of transferring and forming the grooves 30. After the mold 60 is clamped, the layered structure is shaped by applying heat thereto. As a result, the mixture 2a is hardened and forms the plate 2. Further, as a result of the transfer of the uneven surfaces 42 and 52, the grooves 30 and 32 in the state of being covered by the surface layer films 4 and 5 are formed (see FIG. 5I).

After the shaping step (S150), the mold 60 is opened, and the separator 1 is thus completed. After the second shaping material arranging step (S130), a set made up of the intermediate layer film arranging step (S120) and the second shaping material arranging step (S130) may be performed repeatedly one or more times.

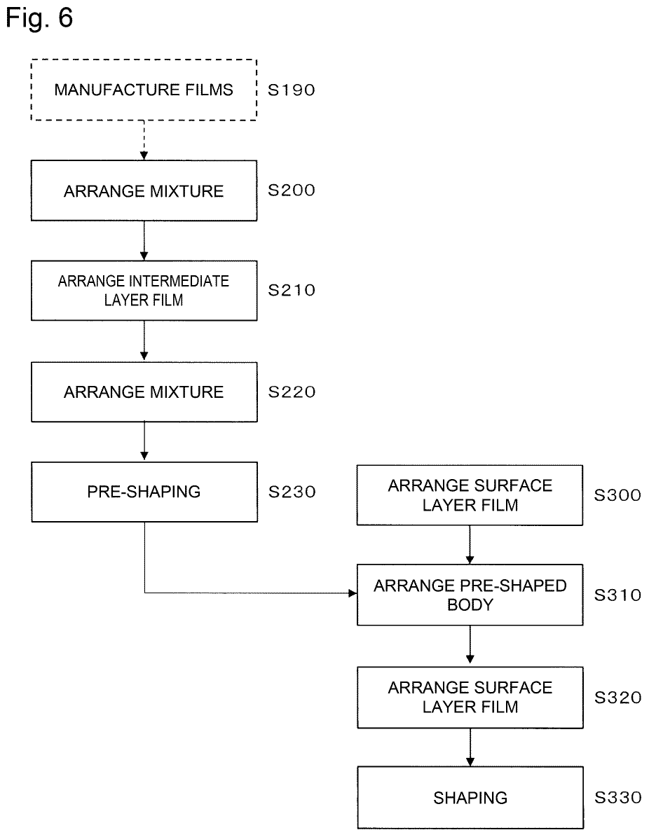

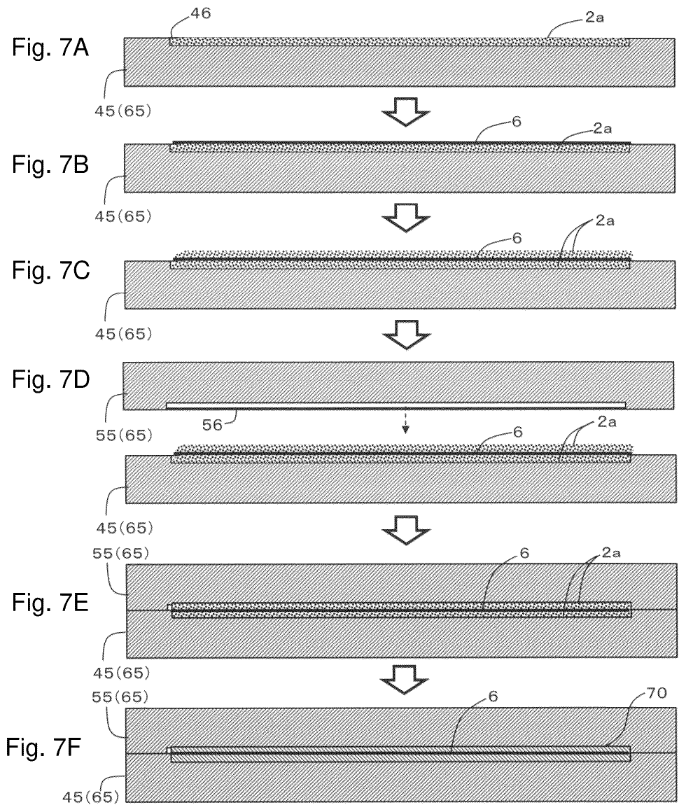

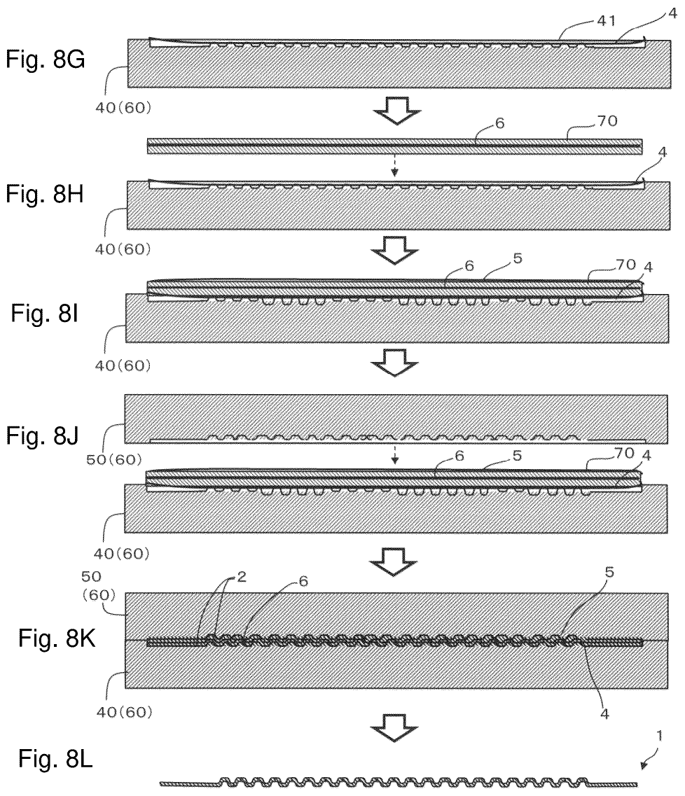

FIG. 6 shows an example of a flow in main steps in a fuel cell separator manufacturing method according to a second embodiment. FIGS. 7A to 7F cross-sectional views of statuses at the steps in the manufacturing method in FIG. 6. FIGS. 8G to 8L present cross-sectional views of statuses at the steps following FIGS. 7A to 7F.

The manufacturing method shown in FIG. 6 is a method for manufacturing the separator 1 by which a shaping material is produced by semi-solidifying a layered structure of the mixture 2a, the intermediate layer film 6, and the mixture 2a, and subsequently, the shaping material is shaped as being sandwiched between the surface layer film 4 and the surface layer film 5. In other words, in the present manufacturing method, before the shaping step, a preliminary shaping step (which may be referred to as a “pre-shaping step”) is performed to obtain the shaping material in the semi-solidified state.

It is possible to manufacture the separator 1 through a film manufacturing step (S190), a first shaping material arranging step (S200), an intermediate layer film arranging step (S210), a second shaping material arranging step (S220), a preliminary shaping step (S230), a first surface layer film arranging step (S300), a pre-shaped body arranging step (S310), a second surface layer film arranging step (S320), and a shaping step (S330). In the following sections, S190 through S230 and S300 through S330 will be explained in detail with reference to FIGS. 6 to 8L.

### (1) The Film Manufacturing Step (S190)

This step is a step of manufacturing a film in the form where the CNTs are dispersed in the resin by mixing the CNTs with the resin in a melted state. In the present embodiment, the surface layer films 4 and 5 and the intermediate layer film 6 are shaped at once. However, the films 4, 5, and 6 may individually be shaped. Further, this step is sufficient when being a step of manufacturing at least the intermediate layer film 6. The surface layer film 4 may be manufactured at any stage before the first surface layer film arranging step (S300). Similarly, the surface layer film 5 may be manufactured at any stage before the second surface layer film arranging step (S320). Furthermore, when a film in the form where the carbon nanotubes are dispersed in the resin is available for purchase or the like without manufacturing the film, it is possible to omit the film manufacturing step (S190).

### (2) The First Shaping Material Arranging Step (S200)

This step is a step of arranging the mixture 2a containing the graphite and the resin in a mold 65, as a shaping material. More specifically, the mixture 2a is supplied to a recessed part 46 of a bottom mold 45 (see FIG. 7A).

### (3) The Intermediate Layer Film Arranging Step (S210)

This step is a step of arranging the intermediate layer film 6 over the mixture 2a in the mold 65. More specifically, the intermediate layer film 6 is placed over the mixture 2a supplied to the recessed part 46 of the bottom mold 45 (see FIG. 7B).

### (4) The Second Shaping Material Arranging Step (S220)

This step is a step of arranging the mixture 2a containing the graphite and the resin on the intermediate layer film 6 in the mold 65, as a shaping material. More specifically, the mixture 2a is supplied to the top of the intermediate layer film 6 in the bottom mold 45 (see FIG. 7C).

### (5) The Preliminary Shaping Step (S230)

This step is a step of producing a pre-shaped body by semi-solidifying the layered structure including the mixture 2a, the intermediate layer film 6, and the mixture 2a. More specifically, a top mold 55 structuring the mold 65 is prepared and placed over the bottom mold 45 on the recessed part 46 side, and the bottom mold 45 and the top mold 55 are closed together (see FIGS. 7D, 7E and 7F). The top mold 55 has a recessed part 56 on the side facing the recessed part 46 of the bottom mold 45. After the mold 65 is clamped, the layered structure is semi-solidified by applying heat thereto. The temperature at this time is lower than the temperature used in the shaping step. As a result, a pre-shaped body (the shaping material in the semi-solidified state) 70 is completed.

### (6) The First Surface Layer Film Arranging Step (S300)

This step is a step of arranging the surface layer film 4 in the mold 60 (see FIG. 8G). The details are the same as the first surface layer film arranging step (S100) in the manufacturing method according to the first embodiment.

### (7) The Pre-Shaped Body Arranging Step (S310)

This step is a step of arranging the pre-shaped body 70 on the surface layer film 4 placed in the recessed part 41 (see FIG. 8H).

### (8) The Second Surface Layer Film Arranging Step (S320)

This step is a step of arranging the surface layer film 5 over the pre-shaped body 70 in the mold 60, after the pre-shaped body arranging step (S310) (see FIG. 8I).

### (9) The Shaping Step (S330)

This step is a step of performing a shaping process by closing the mold 60 while the pre-shaped body 70 (structured with the mixture 2a, the intermediate layer film 6, and the mixture 2a) is sandwiched between the surface layer films 4 and 5. More specifically, the top mold 50 structuring the mold 60 is prepared and placed over the bottom mold 40 on the recessed part 41 side, and the bottom mold 40 and the top mold 50 are closed together (see FIGS. 8J and 8K). After the mold 60 is clamped, a layered body including the surface layer film 4, the pre-shaped body 70, and the surface layer film 5 is shaped by applying heat thereto. As a result, the mixture 2a is hardened and forms the plate 2. Further, as a result of the transfer of the uneven surfaces 42 and 52, the grooves 30 and 32 in the state of being covered by the surface layer films 4 and 5 are formed (see FIG. 8L).

After the shaping step (S330), the mold 60 is opened, and the separator 1 is thus completed. After the second shaping material arranging step (S220), a set made up of the intermediate layer film arranging step (S210) and the second shaping material arranging step (S220) may be performed repeatedly one or more times.

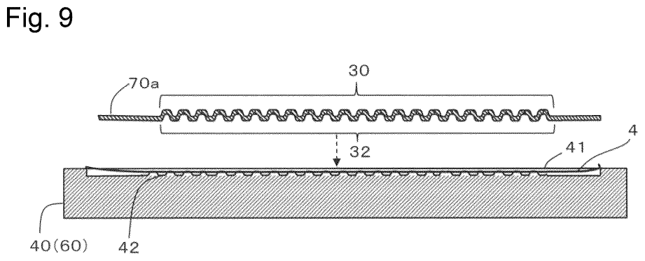

FIG. 9 presents a cross-sectional view of a status when the grooves are formed in a pre-shaped body in a semi-solidified state, in a fuel cell separator manufacturing method according to a modification example.

In the present modification example, the bottom mold 45 and the top mold 55 each have an uneven surface formed on the inner bottom face thereof. In the pre-shaped body arranging step (S310), a pre-shaped body 70a having the grooves 30 and 32 is manufactured. In the pre-shaped body arranging step (S310), the pre-shaped body 70a is arranged on the surface layer film 4, so that the grooves on the pre-shaped body 70a fit the uneven surface 42 (see FIG. 9). After that, the uneven surface 52 of the top mold 50 is fit to the grooves on the pre-shaped body 70a, so that the top mold 50 and the bottom mold 40 are closed together, and the mold 60 is thus clamped. After that, the shaping step (S330) in the manufacturing method according to the second embodiment is performed, and the separator 1 is thus completed (see FIGS. 8K and 8L).

### Second Embodiment

Next, the second embodiment of the present invention will be explained. For the fuel cell separator and the manufacturing method thereof according to the second embodiment, duplicate explanations of some of the elements that are the same as those in the first embodiment shall be omitted, and the explanations in the first embodiment serve as a substitute.

### 1. A Fuel Cell Separator

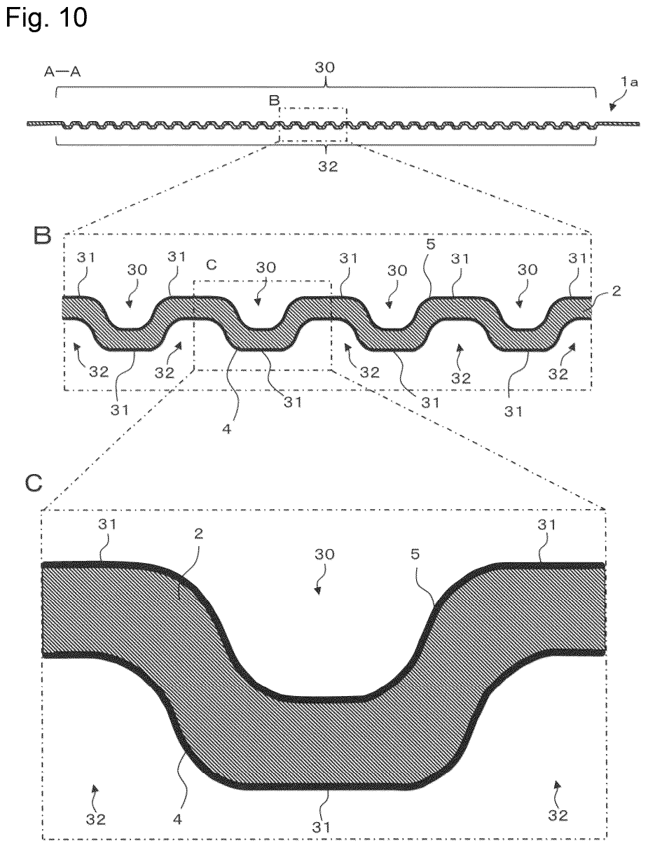

FIG. 10 presents a cross-sectional view of the fuel cell separator according to the second embodiment at A-A similar to FIG. 2, an enlarged view of B which is a part thereof, and an enlarged view of C which is a part of the enlarged view of B.

A separator 1a according to the present embodiment comprises the plate 2 and the surface layer films 4 and 5. The present embodiment does not comprise the intermediate layer film 6, unlike the separator 1 according to the first embodiment. The separator 1a is the same as the separator 1, except for not comprising the intermediate layer film 6.

### 2. A Fuel Cell Separator Manufacturing Method

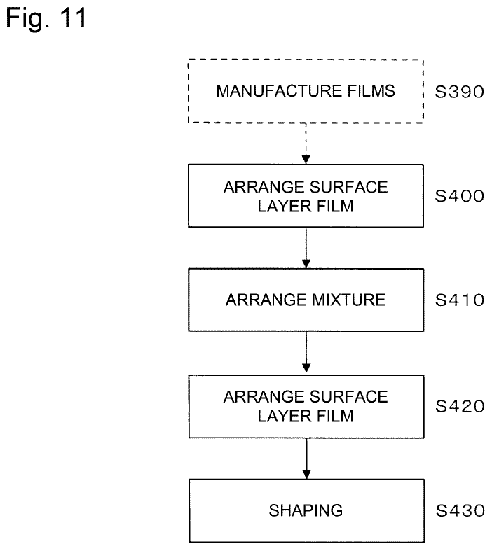

FIG. 11 shows an example of a flow in main steps in a fuel cell separator manufacturing method according to the second embodiment.

The separator 1a includes: a film manufacturing step (S390) of manufacturing the surface layer films 4 and 5 in the form where the carbon nanotubes are dispersed in the resin, as a result of mixing the carbon nanotubes with the resin in a melted state; a first surface layer film arranging step (S400) of arranging the surface layer film 4 in a mold; a shaping material arranging step (S410) of arranging the shaping material containing the graphite and the resin on the surface layer film 4; a second surface layer film arranging step (S420) of arranging the surface layer film 5 over the shaping material; and a shaping step (S430) of performing a shaping process by closing the mold while the shaping material is sandwiched between the surface layer films 4 and 5. The film manufacturing step (S390) corresponds to the film manufacturing step (S90) except for not manufacturing the intermediate layer film 6. The first surface layer film arranging step (S400) and the shaping material arranging step correspond to the first surface layer film arranging step (S100) and to the first shaping material arranging step (S110), respectively. The second surface layer film arranging step (S420) corresponds to the second surface layer film arranging step (S140) except for being performed without arranging the intermediate layer film 6 inside the mixture 2a in the thickness direction thereof. The shaping step (S430) corresponds to the shaping step (S150) except for being performed without arranging the intermediate layer film 6. Accordingly, explanations that are duplicates of those about the manufacturing method of the separator 1 according to the first embodiment above will be omitted.

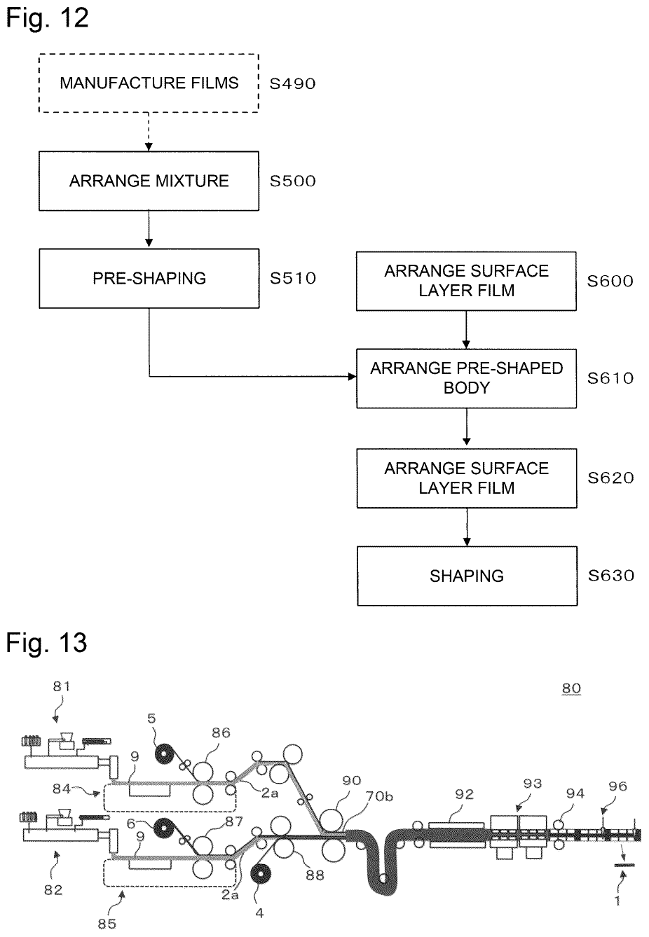

FIG. 12 shows an example of a flow in main steps in a manufacturing method different from FIG. 11.

It is possible to manufacture the separator 1a through a film manufacturing step (S490), a mixture arranging step (S500), a preliminary shaping step (S510), a first surface layer film arranging step (S600), a pre-shaped body arranging step (S610), a second surface layer film arranging step (S620), and a shaping step (S630).

The film manufacturing step (S490) corresponds to the film manufacturing step (S190) except for manufacturing the surface layer films 4 and 5 without manufacturing the intermediate layer film 6. The mixture arranging step (S500) corresponds to the first shaping material arranging step (S200). The preliminary shaping step (S510) corresponds to the preliminary shaping step (S230) except for being performed without arranging the intermediate layer film 6. The first surface layer film arranging step (S600) corresponds to the first surface layer film arranging step (S300). The pre-shaped body arranging step (S610) corresponds to the pre-shaped body arranging step (S310) except for being performed without arranging the intermediate layer film 6. The second surface layer film arranging step (S620) corresponds to the second surface layer film arranging step (S320) except for being performed without arranging the intermediate layer film 6. The shaping step (S630) corresponds to the shaping step (S330) except for being performed without arranging the intermediate layer film 6. Accordingly, explanations that are duplicates of those about the manufacturing method of the separator 1 according to the first embodiment above shown in FIG. 6 will be omitted.

### OTHER EMBODIMENTS

A number of preferable embodiments of the present invention have thus been explained. However, the present invention is not limited to those embodiments and may be carried out with various modifications.

The grooves 30 in the separator 1, 1a may be grooves forming flow paths other than the flow paths in which the gas flows in the directions shown with the white arrows in FIG. 1. Further, the grooves 32 may be grooves forming flow paths in any form. For example, the grooves 30 may be grooves forming linear flow paths extending from one end to the other end of the separator 1, while the grooves 32 may be grooves forming linear flow paths extending in a substantially perpendicular direction to the grooves 30. Further, the separator 1 may be formed without one or both of the grooves 30 and the grooves 32.

In the embodiments described above, the pre-shaped body 70 comprises no grooves corresponding to the grooves 30, 32, but may comprise grooves shallower than the grooves 30, 32. In that situation, when the shaping process is performed by closing the mold 60, it is possible to deepen the shallower grooves formed in advance, to be changed into the grooves 30, 32.

After the shaping step, a trimming step may be performed to trim an extra area of the surface layer films 4 and 5 or the intermediate layer film 6.

In the above embodiments, the manufacturing methods for manufacturing the separators 1 and 1a one by one were explained (see FIGS. 3 to 9 and FIGS. 11 and 12). However, it is also acceptable to manufacture a plurality of separators 1, 1a through a continuous shaping process.

FIG. 13 presents a schematic diagram of a continuous shaping device used in a modification example of a fuel cell separator manufacturing method.

The present modification example presents a method for manufacturing the separators 1 (see FIG. 1 and FIG. 2) through a continuous shaping process. In the modification example, the separators 1 are preferably manufactured by using a continuous shaping device 80 shown in FIG. 13. The continuous shaping device 80 is preferably a device comprising at least: twin screw extruders 81 and 82; screen conveyor vacuum dehydrators 84 and 85; heating rollers 86, 87, 88, and 90; a heater 92, a cooling presser 93, a collecting roller 94, and a cutter 96.

The separators 1 are manufactured by employing the continuous shaping device 80 and performing, in parallel, the first surface layer film arranging step (S100), the first shaping material arranging step (S110), the intermediate layer film arranging step (S120), the second shaping material arranging step (S130), and the second surface layer film arranging step (S140) in the fuel cell separator manufacturing method (see FIG. 3) according to the first embodiment described above. More specifically, to begin with, in the film manufacturing step (S90), the surface layer films 4 and 5 and the intermediate layer film 6 are manufactured in the same manner as described above. Subsequently, graphite, resin, and water are input to the twin screw extruders 81 and 82, so that a slurry 9 extruded through discharge openings at the tip end of the twin screw extruders 81 and 82 is dehydrated by the screen conveyor vacuum dehydrators 84 and 85, to produce the mixture 2a. After that, the heating roller 86, which is on the downstream side, in the mixture 2a transport direction (to the right in FIG. 13), of the screen conveyor vacuum dehydrator 84, arranges the surface layer film 5 over the mixture 2a transported by the screen conveyor vacuum dehydrator 84, to be transported downstream in the transport direction. Further, the heating roller 87, which is on the downstream side, in the transport direction, of the screen conveyor vacuum dehydrator 85, arranges the intermediate layer film 6 over the mixture 2a transported by the screen conveyor vacuum dehydrator 85. In addition, as for the mixture 2a over which the intermediate layer film 6 was placed, the heating roller 88, which is on the downstream side, in the transport direction, of the heating roller 87, arranges the surface layer film 4 underneath the mixture 2a, to be transported downstream in the transport direction. After that, the heating roller 90, which is on the downstream side, in the transport direction, of the heating roller 88, produces a five-layer structure (called “pre-shaped body”) 70b, in which the mixture 2a over which the surface layer film 5 is placed is layered on the intermediate layer film 6, while the mixture 2a is sandwiched between the surface layer film 4 and the intermediate layer film 6. In this manner, the first surface layer film arranging step (S100), the first shaping material arranging step (S110), the intermediate layer film arranging step (S120), the second shaping material arranging step (S130), and the second surface layer film arranging step (S140) are performed in parallel, to produce the pre-shaped body 70b in which the layered structure including the mixture 2a, the intermediate layer film 6, and the mixture 2a is sandwiched between the surface layer films 4 and 5.

Subsequently, in the shaping step (S150), the heater 92, which is on the downstream side, in the transport direction, of the heating roller 90, applies high heat to the pre-shaped body 70b. The long five-layer sheet that has been press-shaped by the cooling presser 93 is further transported downstream in the transport direction, by the collecting roller 94, which is on the downstream side, in the transport direction, of the cooling presser 93. In this situation, the cooling presser 93 comprises the mold 60 comprising the uneven surfaces 42 and 52 capable of transferring and forming the grooves 30 and 32. In other words, on the five-layer sheet, the grooves 30 and 32 in the state of being covered by the surface layer films 4 and 5 are formed as a result of the uneven surfaces 42 and 52 being transferred through the press-shaping process by the cooling presser 93. After that, the long five-layer sheet is cut to a predetermined length by the cutter 96, which is on the downstream side, in the transport direction, of the collecting roller 94, and the separator 1 has thus been manufactured. Alternatively, the continuous shaping device 80 may be employed to manufacture the separators 1a in place of the separators 1 through a continuous shaping process. In that situation, for example, the twin screw extruder 81 and the heating rollers 86 and 90 may be removed from the continuous shaping device 80, so that the surface layer film 5 is arranged in place of the intermediate layer film 6, on the upstream side, in the transport direction, of the heating roller 87.

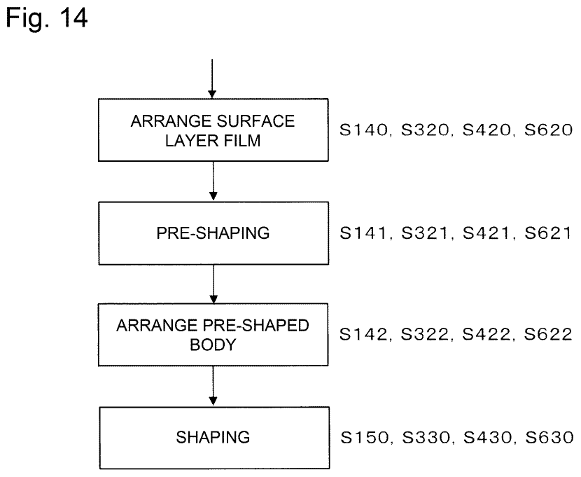

FIG. 14 shows partial steps in the modification example in which the pre-shaped body shown in FIG. 13 is manufactured before the separators are shaped.

Prior to the shaping step, it is also possible to perform a preliminary shaping step to obtain a shaping material in a semi-solidified state, from a layered structure. In that situation, the shaping step may be performed on the shaping material in the semi-solidified state. More specifically, between S140 and S150 in FIG. 3, a pre-shaping process (S141) and a subsequent pre-shaped body arranging process (S142) may be performed. Similarly, between S320 and S330 in FIG. 6, a pre-shaping process (S321) and a subsequent pre-shaped body arranging process (S322) may be performed. Further, between S420 and S430 in FIG. 11, a pre-shaping process (S421) and a subsequent pre-shaped body arranging process (S422) may be performed. Furthermore, between S620 and S630 in FIG. 12, a pre-shaping process (S621) and a subsequent pre-shaped body arranging process (S622) may be performed.

The pre-shaping process (S141, S321, S421, S621) is a step of producing a pre-shaped body by laminating a layered structure including the mixture and the surface layer film (the “intermediate layer film”, if necessary). For example, it is possible to perform this step by preparing the top mold 55 structuring the mold 65 to be placed on the bottom mold 45 on the recessed part 46 side, and closing the bottom mold 45 and the top mold 55 together. The top mold 55 has the recessed part 56 on the side facing the recessed part 46 of the bottom mold 45. After the mold 65 is clamped, heat is applied to laminate the layered structure. The temperature at this time may be higher or may be lower than the melting point of the thermoplastic resin used in the surface layer film. From a viewpoint of productivity, it is preferable to set the shaping temperature lower than the melting point of the thermoplastic resin. At this stage, the surface layer film does not need to be impregnated with the mixture. It is sufficient when the surface layer film is closely adhered to/solidified with the surface of the mixture. As a result of the steps described above, the pre-shaped body (the shaping material in the semi-solidified state) is completed. After that, the pre-shaped body is arranged before a final shaping process is performed, to complete separators.

### EMBODIMENT EXAMPLES

Next, embodiment examples of the present invention will be explained while being compared with comparison examples. The present invention is not limited to the following embodiment examples.

### 1. Main Ingredients of the Plate

### (1) Graphite

As graphite powder serving as a constituent material of the plate of a fuel cell separator (which hereinafter, may be referred to as “separator”), the following two types of graphite powder were used: model number 1707SJ (artificial graphite having an average particle diameter of 125 μm) produced by Oriental Sangyou Co., Ltd.; and model number AT-No. 5S (artificial graphite having an average particle diameter of 52 μm) produced by Oriental Sangyou Co., Ltd.

### (2) Resin

As the resin serving as a constituent material of the plate of the separator, polyphenylene sulfide (PPS) powder was used. Used as the PPS was PPS fine powder adjusted to have an average particle diameter of 50 μm obtained by freezing and pulverizing PPS powder in a flake form of Torelina M2888 produced by Toray Industries, Inc.

### (3) Aramid Fiber

As the aramid fiber serving as a constituent material of the plate of the separator, the following was used: Technora T32PNW 3-12 (having an average fiber length of 3 mm and an average fiber diameter of 12 μm) produced by Teijin Limited and Twaron (registered trademark) D8016 (having an average fiber length of 0.8 mm) produced by Teijin Limited.

### 2. Main Ingredients of the Surface Layer Films

### (1) Resin

As the resin serving as a constituent material of the surface layer films, PPS was used. Used as the PPS was model number E2180 produced by Toray Industries, Inc.

### (2) Carbon Nanotubes (CNTs)

As the CNTs serving as a constituent material of the surface layer films, the following three types of CNTs were used: CNTs A (MWCNTs: diameter 5 nm to 15 nm; length: 1 Lm to 15 Lm); CNTs B (MWCNTs: diameter 40 nm to 60 nm; length: 5 ™ to 20 ™); and CNTs C (MWCNTs: diameter 90 nm to 155 nm; length: 5 μm to 20 μm).

### 3. Mold

Used as the mold was a mold of a top/bottom separate type using pre-hardened steel NAK80 produced by Daido Steel Co., Ltd. as a material. Formed inside the mold in a closed state is a space (approximately 63 cm³) in which it is possible to shape the separator. Further, formed in the inner bottom part of each of the top and the bottom molds is the uneven surface for forming the grooves of the separator.

### 4. Evaluation Methods

### (1) Penetration Resistance

The penetration resistance values of the separators were measured by using the following measuring method: The two sides of each separator were held between a pair of gas diffusion layer base members (model number TGP-H-060 produced by Toray Industries, Inc.). The two sides of the obtained layered body were further held between a pair of electrodes. While a prescribed level of pressure (1 MPa) was applied to the entire layered body including the electrodes, the electric resistance value in the lamination direction was measured with a constant electric current flow, by using a resistance meter (model number: RM3544) produced by Hioki E. E. Corporation. The resistance value obtained as a result was multiplied by the pressurized area to obtain a penetration resistance value. A penetration resistance value smaller than 25 mΩ·cm² was evaluated as a pass.

### (2) Bending Test

A bending test for the separators was performed by using a device (a Tensilon universal tester, RTC-1310A) produced by Orientec Co., Ltd., according to JIS K7171.

### Bending Strength

A bending strength exceeding 40 MPa was evaluated as a pass.

### Bending Strain

A bending strain exceeding 0.7% was evaluated as a pass.

### (3) He Gas Permeability Coefficient at 23° C.

While using He gas, gas permeability coefficients of the separators were measured by using a gas permeability measuring device (K-315-N-03) produced by Rika Seiki Kogyo K. K., according to JIS K7126-1. A permeability coefficient smaller than 1.0×10⁻¹⁵ mol·m/m²·sec·Pa was evaluated as a pass.

### (4) Overall Evaluations

When the evaluations of all the property values were evaluated as a pass, the product was evaluated as a pass evaluation of at least one of the property values was evaluated as a fail, the product was evaluated as a fail (“NG” in the table).

### 5. Manufacturing the Fuel Cell Separators

### EMBODIMENT EXAMPLES

### (1) Embodiment Example 1

The following was prepared: 977.8 parts by mass (where 1 part by mass=1 g; the same applies to <Embodiment Examples> hereinafter) of artificial graphite particles (model number: 1707SJ); 244.4 parts by mass of artificial graphite particles (model number AT-No. 5S); 100 parts by mass of PPS powder; 62.5 parts by mass of aramid fiber (Technora T32PNW 3-12); and 4.2 parts by mass of aramid fiber (Twaron (registered trademark) D8016). A slurry having a solid content of 1% was produced by mixing and dispersing the above in water. The slurry was input to a strainer comprising an input opening of a 25 cm square, to obtain a wet sheet, which was a sheet formed with residue from the straining. The wet sheet was set on a presser heated to 150° C. and pressured and heated for approximately 20 minutes with surface pressure of 8 MPa. By drying the wet sheet and removing the moisture, a pre-shaped body having a thickness of 2 mm and an area-based weight of 2200 g/m² was manufactured in which the artificial graphite particles, the PPS particles, and the aramid fiber were dispersed.

Further, 99 parts by mass of PPS and 1 part by mass of CNTs A were input to a supermixer and agitated and mixed for 5 minutes at 23° C. to prepare a mixture. The mixture was melted and kneaded at a shaping temperature of 320° C. by using a twin screw extruder having a vacuum pump. A result extruded from a die at a tip end part of the twin screw extruder was prepared as a shaped material serving as intermediates of pellet pieces. Subsequently, by using a twin screw extruder comprising a T-die, a PPS film (10 μm thick) containing CNTs by 1% (hereinafter, “CNT-containing PPS film”) was manufactured.

Next, the CNT-containing PPS film was placed in the recessed part inside the bottom mold structuring the separate-type mold, and the abovementioned pre-shaped body was supplied to the top of the film. After that, the CNT-containing PPS film was placed over the pre-shaped body. Subsequently, a shaping process was performed by closing together the top mold and the bottom mold structuring the separate-type mold. The shaping process was performed by applying heat until the temperature of the mold reached 340° C. with surface pressure of 4 MPa, and after the surface pressure was increased to 90 MPa, the workpiece was held for one minute. Subsequently, while keeping the pressure the same, the mold was cooled under pressure until the temperature reached 30° C. When the shaping process was finished, the mold was opened to take out the shaped body, and the manufacture of a separator was thus finished. The separator was evaluated by using the abovementioned evaluation method.

### (2) Embodiment Example 2

Except for using, as the surface layer film, a PPS film (10 μm thick) containing CNTs by 2% prepared with 98 parts by mass of PPS and 2 parts by mass of CNTs A, a separator was manufactured and evaluated under the same conditions as those in Embodiment Example 1.

### (3) Embodiment Example 3

Except for using, as the surface layer film, a PPS film (10 μm thick) containing CNTs B by 1% in place of CNTs A, a separator was manufactured and evaluated under the same conditions as those in Embodiment Example 1.

### (4) Embodiment Example 4

Except for using, as the surface layer film, a PPS film (10 μm thick) containing CNTs by 2% prepared with 98 parts by mass of PPS and 2 parts by mass of CNTs B, a separator was manufactured and evaluated under the same conditions as those in Embodiment Example 3.

### (5) Embodiment Example 5

Except for using, as the surface layer film, a PPS film (10 μm thick) containing CNTs by 4% prepared with 96 parts by mass of PPS and 4 parts by mass of CNTs B, a separator was manufactured and evaluated under the same conditions as those in Embodiment Example 3.

### (6) Embodiment Example 6

Except for using, as the surface layer film, a PPS film (10 μm thick) containing CNTs C by 4% in place of CNTs B, a separator was manufactured and evaluated under the same conditions as those in Embodiment Example 5.

### (7) Embodiment Example 7

Except that a CNT-containing PPS film having a thickness of 50 μm was manufactured, a separator was manufactured and evaluated under the same conditions as those in Embodiment Example 2.

### (8) Embodiment Example 8

The following was prepared: 977.8 parts by mass of artificial graphite particles (model number: 1707SJ); 244.4 parts by mass of artificial graphite particles (model number AT-No. 5S); 100 parts by mass of PPS powder; 62.5 parts by mass of aramid fiber (Technora T32PNW 3-12); and 4.2 parts by mass of aramid fiber (Twaron (registered trademark) D8016). A slurry having a solid content of 1% was produced by mixing and dispersing the above in water. The mixture was input to a strainer comprising an input opening of a 25 cm square, to obtain a wet sheet, which was a sheet formed with residue from the straining. The wet sheet was set on a presser heated to 150° C. and pressured and heated for approximately 20 minutes with surface pressure of 8 MPa. By drying the wet sheet and removing the moisture, a pre-plate having a thickness of 1 mm and an area-based weight of 1100 g/m² was manufactured in which the artificial graphite particles, the PPS particles, and the aramid fiber were dispersed. With the same procedure as described above, another pre-plate was manufactured to prepare two pre-plates in total. In the recessed part inside the bottom mold structuring a separate-type mold, a CNT-containing PPS film having a thickness of 10 μm and having the same composition as that in Embodiment Example 2 was placed as a surface layer film. One of the pre-plate was supplied to the top of the film. Subsequently, as an intermediate layer film, a CNT-containing PPS film having a thickness of 20 μm and having the same composition as that in Embodiment Example 2 was placed thereon. Next, the other pre-plate was supplied to the top of the intermediate layer film. Subsequently, as a surface layer film over the pre-plate, a CNT-containing PPS film having a thickness of 10 μm and having the same composition as that in Embodiment Example 2 was placed thereon. After that, by closing together the top mold and the bottom mold structuring the separate-type mold, a separator was manufactured and evaluated under the same condition as those in Embodiment Example 2.

### COMPARISON EXAMPLES

### (1) Comparison Example 1

To the recessed part inside the bottom mold structuring a separate-type mold, the pre-shaped body in Embodiment Example 1 was supplied, to perform a shaping process by closing together the top mold and the bottom mold structuring the separation-type mold. The shaping process was performed by applying heat until the temperature of the mold reached 340° C. with surface pressure of 4 MPa, and after the surface pressure was increased to 90 MPa, the workpiece was held for one minute. Subsequently, while keeping the pressure the same, the mold was cooled under pressure until the temperature reached 30° C. When the shaping process was finished, the mold was opened to take out the shaped body, and the manufacture of a separator was thus finished. Comparison Example 1 was produced without using any surface layer film. The separator was evaluated by using the abovementioned evaluation method.

### (2) Comparison Example 2

Except for using a PPS film (model number: E2180 produced by Toray Industries, Inc.) having a thickness of 10 μm in place of the CNT-containing PPS film, a separator was manufactured and evaluated under the same conditions as those in Embodiment Example 1. Comparison Example 2 was produced by using the PPS film containing no CNTs as the surface layer film.

### 6. Results

Table 1, Table 2, and Table 3 present the manufacturing conditions of the embodiment examples and the comparison examples, together with evaluation results.

TABLE 1

| | | EMBODIMENT | EMBODIMENT | EMBODIMENT | EMBODIMENT |
|---|---|---|---|---|---|
| | | EXAMPLE 1 | EXAMPLE 2 | EXAMPLE 3 | EXAMPLE 4 |
| SURFACE | MATERIAL | CNT-CONTAINING | CNT-CONTAINING | CNT-CONTAINING | CNT-CONTAINING |
| LAYER FILM | | PPS | PPS | PPS | PPS |
| | THICKNESS | 10 | 10 | 10 | 10 |
| | μm | | | | |
| | FILLER | CNT A | CNT A | CNT B | CNT B |
| | FILLER DIAMETER | 5-15 | 5-15 | 40-60 | 40-60 |
| | nm | | | | |
| | FILLER ADDED | 1 | 2 | 1 | 2 |
| | AMOUNT % | | | | |
| INTERMEDIATE | MATERIAL | NONE | NONE | NONE | NONE |
| LAYER FILM | THICKNESS | 0 | 0 | 0 | 0 |
| | μm | | | | |
| | FILLER | NONE | NONE | NONE | NONE |
| | FILLER DIAMETER | 0 | 0 | 0 | 0 |
| | nm | | | | |
| | FILLER ADDED | 0 | 0 | 0 | 0 |
| | AMOUNT % | | | | |

| | | | | |
|---|---|---|---|---|
| PENETRATION RESISTANCE | 18.71 | 19.14 | 19.88 | 19.99 |
| mΩ · cm² | | | | |
| BENDING STRENGTH | 66.0 | 59.2 | 64.8 | 57.8 |
| MPa | | | | |
| BENDING STRAIN | 1.3 | 1.4 | 1.4 | 1.5 |
| % | | | | |
| He GAS PERMEABILITY COEFFICIENT | 8.15E−17 | 8.49E−17 | 8.42E−17 | 1.06E−16 |
| mol · m/m² · sec · Pa | | | | |
| OVERALL EVALUATION | VG | VG | VG | VG |

TABLE 2

| | | EMBODIMENT | EMBODIMENT | EMBODIMENT | EMBODIMENT |
|---|---|---|---|---|---|
| | | EXAMPLE 5 | EXAMPLE 6 | EXAMPLE 7 | EXAMPLE 8 |
| SURFACE | MATERIAL | CNT-CONTAINING | CNT-CONTAINING | CNT-CONTAINING | CNT-CONTAINING |
| LAYER FILM | | PPS | PPS | PPS | PPS |
| | THICKNESS | 10 | 10 | 50 | 10 |
| | μm | | | | |
| | FILLER | CNT B | CNT C | CNT A | CNT A |
| | FILLER DIAMETER | 40-60 | 90-155 | 5-15 | 5-15 |
| | nm | | | | |
| | FILLER ADDED | 4 | 4 | 2 | 2 |
| | AMOUNT % | | | | |
| INTERMEDIATE | MATERIAL | NONE | NONE | NONE | CNT-CONTAINING |
| LAYER FILM | | | | | PPS |
| | THICKNESS | 0 | 0 | 0 | 50 |
| | μm | | | | |
| | FILLER | NONE | NONE | NONE | CNT A |
| | FILLER DIAMETER | 0 | 0 | 0 | 5-15 |
| | nm | | | | |
| | FILLER ADDED | 0 | 0 | 0 | 2 |
| | AMOUNT % | | | | |

| | | | | |
|---|---|---|---|---|
| PENETRATION RESISTANCE | 20.63 | 20.90 | 23.54 | 16.60 |
| mΩ · cm² | | | | |
| BENDING STRENGTH | 58.2 | 68.9 | 80.3 | 62.0 |
| MPa | | | | |
| BENDING STRAIN | 1.5 | 1.6 | 1.7 | 1.2 |
| % | | | | |
| He GAS PERMEABILITY COEFFICIENT | 6.69E−16 | 9.00E−17 | 1.06E−16 | 7.56E−17 |
| mol · m/m2 · sec · Pa | | | | |
| OVERALL EVALUATION | VG | VG | VG | VG |

TABLE 3

| | | COMPARISON | COMPARISON |
|---|---|---|---|
| | | EXAMPLE 1 | EXAMPLE 2 |
| SURFACE | MATERIAL | NONE | PPS |
| LAYER FILM | THICKNESS | 0 | 10 |
| | μm | | |
| | FILLER | NONE | NONE |
| | FILLER DIAMETER | 0 | 0 |
| | nm | | |
| | FILLER ADDED | 0 | 0 |
| | AMOUNT % | | |
| INTERMEDIATE | MATERIAL | NONE | NONE |
| LAYER FILM | THICKNESS | 0 | 0 |
| | μm | | |
| | FILLER | NONE | NONE |
| | FILLER DIAMETER | 0 | 0 |
| | nm | | |
| | FILLER ADDED | 0 | 0 |
| | AMOUNT % | | |

| | | |
|---|---|---|
| PENETRATION RESISTANCE | 16.48 | 27.40 |
| mΩ · cm² | | |
| BENDING STRENGTH | 53.4 | 61.2 |
| MPa | | |
| BENDING STRAIN | 1.4 | 1.6 |
| % | | |
| He GAS PERMEABILITY COEFFICIENT | 2.29E−12 | 2.47E−15 |
| mol · m/m² · sec · Pa | | |
| OVERALL EVALUATION | NG | NG |

As for Comparison Examples 1 and 2, at least one of the items among the penetration resistance value, the bending strength, the bending strain, and the He gas permeability coefficient was evaluated as a fail. In contrast, Embodiment Examples 1 to 8 were evaluated as a pass for all the properties.

### Film

From the results presented above, by comparing Comparison Example 1 with Embodiment Examples 1 to 8, we were able to confirm the advantageous effects of using the CNT-containing PPS film. Further, by comparing Comparison Example 2 with Embodiment Examples 1 to 8, we were able to confirm the advantageous effects of having the CNTs contained as a constituent material of the surface layer films.

### INDUSTRIAL APPLICABILITY

The fuel cell separator according to the present invention is applicable to fuel cells.

1. A fuel cell separator comprising:
a plate that contains graphite and resin and comprises, on a surface thereof, a groove serving as a flow path; and
a surface layer film that covers surfaces on both sides of the plate in a thickness direction thereof, including the groove and the surfaces of the plate other than the groove, wherein
the surface layer film contains resin and carbon nanotubes.

2. The fuel cell separator of claim 1, wherein
the surface layer film contains polyphenylene sulfide as the resin.

3. The fuel cell separator of claim 1, wherein
a thickness of the surface layer film is in a range of 2 μm to 75 μm inclusive.

4. The fuel cell separator of claim 1, wherein
the carbon nanotubes are contained in an amount ranging from 0.5 parts by mass to 5 parts by mass inclusive, with respect to 100 parts by mass of the resin.

5. The fuel cell separator of claim 1, wherein
the carbon nanotubes are multi-walled carbon nanotubes.

6. The fuel cell separator of claim 1, further comprising:
an intermediate layer film that is provided inside the plate in the thickness direction thereof and that divides the thickness direction thereof into at least two regions, wherein
the intermediate layer film contains resin and carbon nanotubes.

7. The fuel cell separator of claim 6, comprising:
two or more layers of the intermediate layer film.

8. The fuel cell separator of claim 6, wherein
a thickness of the intermediate layer film is larger than a thickness of the surface layer film.

9. The fuel cell separator of claim 1, wherein
the plate contains aramid fiber different from the resin.

10. A method for manufacturing the fuel cell separator of claim 1, comprising:
a first surface layer film arranging step of arranging the surface layer film in a mold;
a shaping material arranging step of arranging a shaping material containing graphite and resin on the surface layer film;
a second surface layer film arranging step of arranging the surface layer film over the shaping material; and
a shaping step of performing a shaping process by closing the mold while the shaping material is sandwiched between the surface layer films.

11. The method of claim 10, wherein
the mold comprises, on inside thereof, an uneven surface for transferring the groove, and
in the shaping step, the shaping material is shaped and the groove is formed, by using the mold comprising the uneven surface.

12. The method of claim 10, further comprising:
a preliminary shaping step of obtaining, prior to the shaping material arranging step, the shaping material in a semi-solidified state from a mixture containing the graphite and the resin, wherein
in the shaping material arranging step, the shaping material in the semi-solidified state is arranged on the surface layer film.

13. The method of claim 10, further comprising:
an intermediate layer film arranging step of arranging, over the shaping material in the mold, an intermediate layer film that is provided inside the plate in the thickness direction thereof and that divides the thickness direction thereof into at least two regions, wherein
the shaping material arranging step includes
a first shaping material arranging step of arranging, on the surface layer film, a mixture containing the graphite and the resin as the shaping material, and
a second shaping material arranging step of arranging, on the intermediate layer film, a mixture containing the graphite and the resin, as the shaping material,
in the intermediate layer film arranging step, the intermediate layer film is arranged over the mixture arranged in the first shaping material arranging step,
in the shaping step, the shaping process is performed by closing the mold while a layered structure including at least the mixture, the intermediate layer film, and the mixture is sandwiched between the surface layer films, and
before the shaping step, the intermediate layer film arranging step and the second shaping material arranging step are each performed once or two or more times repeatedly.

14. The method of claim 13, further comprising:
a preliminary shaping step of obtaining, prior to the second surface layer film arranging step, the shaping material in a semi-solidified state from the layered structure, wherein
in the second surface layer film arranging step, the surface layer film is arranged over the shaping material in the semi-solidified state, and
in the shaping step, the shaping process is performed by closing the mold while the shaping material in the semi-solidified state is sandwiched between the surface layer films.

15. The method of claim 10, wherein
prior to the shaping step, a preliminary shaping step is performed to obtain the shaping material in the semi-solidified state from the layered structure, and
the shaping step is performed on the shaping material in the semi-solidified sate.

16. The method of claim 10, further comprising:
a film manufacturing step of manufacturing the surface layer film and/or the intermediate layer film in a form where the carbon nanotubes are dispersed in the resin as a result of mixing the carbon nanotubes with the resin in a melted state.
